(19) United States
(12) Patent Application Publication
(10) Pub. No.: US 2006/0088142 A1
(43) Pub. Date: Apr. 27, 2006

(54) Emergency communication system

(75) Inventor: Hyung Pil Kim, Busan (KR)

Correspondence Address: ST. ONGE STEWARD JOHNSTON & REENS, LLC, 986 BEDFORD STREET, STAMFORD, CT, 06905-5619, US

(73) Assignee: SOS Telecom Co., Ltd., Busan (KR)

(21) Appl. No.: 11/296,877

(22) Filed: Dec. 9, 2005

Related U.S. Application Data
(63) Continuation of application No. PCT/KR03/02018, filed on Sep. 30, 2003.

(30) Foreign Application Priority Data
Jun. 9, 2003 (KR) 10-2003-36654

(51) Int. Cl. H04M 11/04

(52) U.S. Cl. 379/37; 379/45

(57) ABSTRACT

Disclosed is a system for informing of an emergency state via a line telephone or a cellular phone at emergency situation. The system includes an on/off switch for maintaining the system in a standby state, a magnetic switch and an infrared sensor each connected in series to the on/off switch for detecting occurrence of an accident, a relay connected in series to the magnetic switch and infrared sensor and operated by the switch and infrared sensor, and a line telephone having a hook switch operated by the relay. The line telephone dials a telephone, of which a phone number is previously designated, by the hook switch.

### CROSS-REFERENCE TO RELATED APPLICATIONS

This application is a continuation of International Patent Application No. PCT/KR2003/002018 filed on Sep. 30, 2003, which designates the United States and claims priority of Korean Patent Application No. 10-2003-36654 filed on Jun. 9, 2003.

### FIELD OF THE INVENTION

The present invention relates to an emergency communication system using cable and wireless, and more particularly, to a system for informing of an emergency state via a line telephone or a cellular phone at emergency situation.

### BACKGROUND OF THE INVENTION

In general, a security system is installed in stores, buildings, offices and the like. When trespassing without permission, such a system turns on an alarm or automatically communicates with a fire station, a police station or a security company to cope with the situation. A conventional emergency communication system adopts a dedicated wire communication.

In such a case, there is a problem that a cost of installing the cable to the fire station or police station is excessive. In particular, in the case where a trespasser cuts a dedicated cable network, the emergency communication system is not available, thereby performing a theftproof function. Further, since the emergency situation is not informed an owner of the store or a head of a family, he or she cannot positively cope with the situation.

### SUMMARY OF THE INVENTION

Therefore, an object of the present invention is to solve the problems involved in the prior art, and to provide an emergency communication system capable of promptly informing an owner, a head or a manager of occurrence of emergency situation.

Another object of the present invention is to provide an emergency communication system capable of promptly informing a manager of occurrence of emergency situation via a line telephone or a cellular phone supported by a common line-telephone network or a cellular phone network.

In order to accomplish the above and other objects, there is provided an emergency communication system comprising: an on/off switch for maintaining the system in a standby state; a magnetic switch and an infrared sensor each connected in series to the on/off switch for detecting occurrence of an accident; a relay connected in series to the magnetic switch and infrared sensor and operated by the switch and infrared sensor; and a line telephone having a hook switch operated by the relay; wherein the line telephone dials a telephone, of which a phone number is previously designated, by the hook switch.

Preferably, the system further comprises an alarm generating unit for generating an alarm signal, when the relay is operated.

According to another aspect of the present invention, there is provided an emergency communication system comprising: an on/off switch for maintaining the system in a standby state; a magnetic switch and an infrared sensor each connected in series to the on/off switch for detecting occurrence of an accident; a bell sound amplifying/detecting unit for amplifying and detecting a bell sound of a cellular phone; a relay connected in series to the magnetic switch, the infrared sensor, and the bell sound amplifying/detecting unit and operated by the switch, the infrared sensor and the bell sound amplifying/detecting unit; and a cellular phone operated by the relay.

Preferably, the system further comprises a camera built in the cellular phone for transferring an image in real time.

### BRIEF DESCRIPTION OF THE DRAWINGS

The above objects, other features and advantages of the present invention will become more apparent by describing the preferred embodiment thereof with reference to the accompanying drawings, in which:

FIG. 1 is a view showing a construction of an emergency communication system using a line telephone phone according to a preferred embodiment of the present invention.

FIG. 2 is a view showing a construction of an emergency communication system using a cellular phone according to another preferred embodiment of the present invention.

### DETAILED DESCRIPTION OF THE INVENTION

Reference will now be made in detail to preferred embodiments of the present invention, examples of which are illustrated in the accompanying drawings.

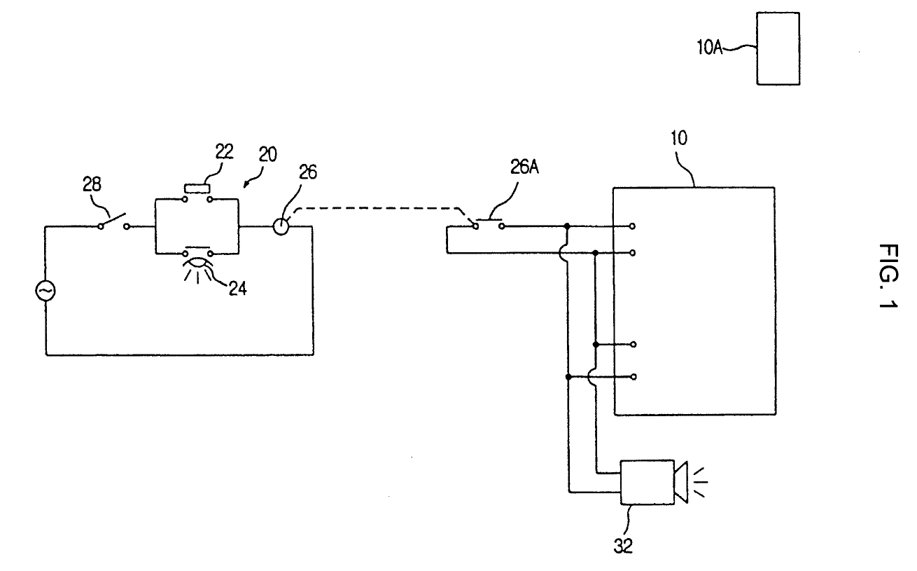

An emergency communication system using a line telephone phone according to a preferred embodiment of the present invention includes, as shown in FIG. 1, a line telephone 10 installed to any place of a building, store or home, and a detecting unit 20 installed to any place of the building, store or home and connected to the line telephone 10. The detecting unit 20 includes a magnetic switch 22 for preventing opening of a door and an infrared sensor 24.

The detecting unit 20 informs a manager's telephone 10A previously inputted in the line telephone 10 of results detected by the infrared sensor 24. A manager can verify the current situation of the building, store or home at a remote place to positively cope with trespass and theft.

Specifically, if the magnetic switch 22 for preventing the opening of the door and the infrared sensor 24 are operated due to the trespass, a relay 26 operates a hook switch of the line telephone 10. Accordingly, the line telephone dials the manager's telephone 10A of previously designated phone number. An alarm generating unit 32 is connected to a contact point 26A′ of the relay 26 to generate an alarm signal around the spot where the line telephone is installed. Preferably, the line telephone adopts a common line-telephone network.

With the emergency communication system according to the present invention, an on/off switch 28 connected in series to the magnetic switch 22 and the infrared sensor 24 stays in a switch on-state. When trespassing without permission, the relay 26 is operated by the magnetic switch 22 and the infrared sensor 24. Accordingly, the system of the present invention informs promptly the manager's telephone 10A of the emergency situation, and operates the alarm generating unit 32 to generate the alarm around the spot.

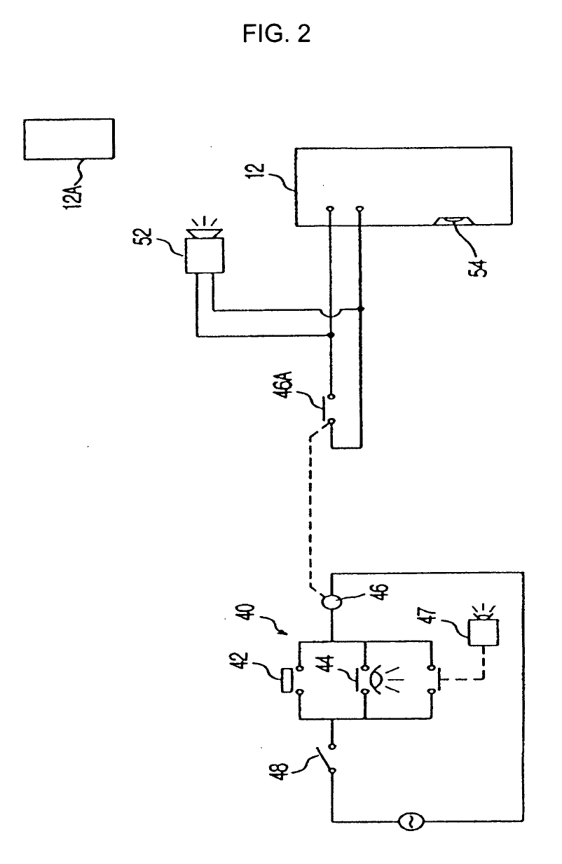

FIG. 2 is a view showing a construction of an emergency communication system using a cellular phone according to another preferred embodiment of the present invention.

Referring to FIG. 2, the emergency communication system according to the present invention includes a cellular phone 12 installed to any place of a building, store or home, and a detecting unit 40 installed to any place of the building, store or home and connected to the cellular phone 12. The detecting unit 40 includes a magnetic switch 42 for preventing opening of a door, an infrared sensor 44, and a bell sound amplifying/detecting unit 47.

The detecting unit 20 informs a manager's cellular phone 12A previously inputted in the cellular phone 12 of results detected by the infrared sensor 44. A manager can verify the current situation of the building, store or home at a remote place to positively cope with trespass and theft.

Specifically, if the magnetic switch 42 for preventing the opening of the door and the infrared sensor 44 are operated due to the trespass, a relay 46 operates the cellular phone 12. Accordingly, the cellular phone 12 dials the manager's cellular phone 12A of previously designated phone number. An alarm generating unit 52 is connected to a contact point 46A′ of the relay 46 to generate an alarm signal around the spot where the cellular phone is installed.

Further, an actual situation of the spot may be transferred in an image communication way to the manger's cellular phone 12A through a camera 54 built in the cellular phone 12 in real time. In addition, if the manager calls the cellular phone 12 of the spot to see the actual situation of the spot from the external, the cellular phone 12 rings. At that time, the bell sound amplifying/detecting unit 47 amplifies the bell sound and detects it, and the relay 46 is switched on. Accordingly, the cellular phone 12 is converted into a receiving state, and the camera 54 built in the cellular phone transfers the actual situation of the interior of the spot as an image. Preferably, the cellular phone 12 adopts a common cellular telephone network.

Specifically, an on/off switch 48 connected in series to the magnetic switch 42 and the infrared sensor 44 stays in a switch on-state. When trespassing without permission, the relay 46 is operated by the magnetic switch 42 and the infrared sensor 44. Accordingly, the system of the present invention informs promptly the manager's telephone 12A of the emergency situation, and operates the alarm generating unit 52 to generate the alarm around the spot.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

As apparent from the above description, the emergency communication system of the present invention can promptly inform a manager's telephone of the occurrence of emergency situation via a line telephone or a cellular phone supported by a common line-telephone network or cellular phone network.

Further, in the case where a trespasser cuts a dedicated cable network, the present invention can prevent a possible damage. In addition, the system informs the manager of the current situation via the common line-telephone network or cellular phone network, thereby eliminating the cost of installing the dedicated cable network.

Furthermore, the manager can receive the actual situation of the spot via the camera built in the cellular phone in real time, thereby being help to cope with handling of the accident. Also, the manager can determine at a remote whether or not the detecting unit is properly operated, thereby reducing an unnecessary time to cope with the situation.

What is claimed is:

1. An emergency communication system comprising:
an on/off switch for maintaining the system in a standby state;
a magnetic switch and an infrared sensor each connected in series to the on/off switch for detecting occurrence of an accident;
a relay connected in series to the magnetic switch and infrared sensor and operated by the switch and infrared sensor; and
a line telephone having a hook switch operated by the relay;
wherein the line telephone dials a telephone, of which a phone number is previously designated, by the hook switch.

2. The emergency communication system as claimed in claim 1, further comprising an alarm generating unit for generating an alarm signal, when the relay is operated.

3. An emergency communication system comprising:
an on/off switch for maintaining the system in a standby state;
a magnetic switch and an infrared sensor each connected in series to the on/off switch for detecting occurrence of an accident;
a bell sound amplifying/detecting unit for amplifying and detecting a bell sound of a cellular phone;
a relay connected in series to the magnetic switch, the infrared sensor, and the bell sound amplifying/detecting unit and operated by the switch, the infrared sensor and the bell sound amplifying/detecting unit; and
a cellular phone operated by the relay.

4. The emergency communication system as claimed in claim 3, further comprising an alarm generating unit for generating an alarm signal, when the relay is operated.

5. The emergency communication system as claimed in claim 3, further comprising a camera built in the cellular phone for transferring an image in real time.
